(19) United States
(12) Patent Application Publication
(10) Pub. No.: US 2011/0270668 A1
(43) Pub. Date: Nov. 3, 2011

(54) Methods and systems for effective processing of coupons or loyalty cards using a mobile device

(76) Inventors: Christopher Fagan, Rowlett, TX (US); Ross Bates, Dallas, TX (US)

(21) Appl. No.: 13/068,035

(22) Filed: Apr. 28, 2011

Related U.S. Application Data
(60) Provisional application No. 61/343,304, filed on Apr. 28, 2010.

(51) Int. Cl. G06Q 30/00; G06F 17/00

(52) U.S. Cl. 705/14.36; 235/375

(57) ABSTRACT

The invention provides methods and systems for mobile device users to generate and populate a rolling profile for consumers.

### CROSS-REFERENCE TO RELATED APPLICATION

### Claim of Priority

This Application is related to and claims priority U.S. Patent Application No. 61/343,304 entitled A METHOD AND SYSTEM FOR AN EFFECTIVE PROCESSING OF COUPONS OR LOYALTY CARDS USING A MOBILE DEVICE which was filed on Apr. 28, 2010, which names at least Chris Fagan as a common inventor.

### STATEMENT REGARDING FEDERALLY SPONSORED RESEARCH OR DEVELOPMENT

Not applicable.

### FIELD OF THE INVENTION

This invention relates generally to processing loyalty cards, and the targeted delivery of electronic coupons. More specifically, the claimed invention depicts a mechanism for users or consumers to generate “rolling profiles” when enrolling in loyalty programs and/or receiving digital coupons.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Customer loyalty programs have gained sophistication since the days of green-stamps. Since the mid-1990s, retailers and service providers (collectively, “retailers”) have used the power of database storage to accumulate tremendous amounts of customer information via loyalty card programs. However, as the numbers of these programs have grown, so have problems with the programs on the user-level. For example, some consumers find the programs offensive—there is sometimes the perception that there is nothing in it for them. Additionally, it is time consuming to fill out all those loyalty card program applications—not to mention the inconvenience of carrying perhaps a dozen or more loyalty cards in one's wallet or on a key ring. Further, beyond inconvenience, the cards sometimes are lost and/or fall off of the key ring, leading to an increasingly frustrating user experience. Therefore, there exist the need for a system and method for enabling a user to easily join and manage their loyalty cards. The present invention provides inventive solutions to these problems.

### SUMMARY OF THE INVENTION

This invention provides a method and a system for mobile device users to generate and populate a rolling profile for consumers. The invention first initiates a first loyalty card program application request which is associated with a first loyalty card program and a loyalty card enrollee. The first loyalty card application has data fields, each data field being either a mandatory data field or an optional data field, where for at least each mandatory data field, the user inputs data. The invention then stores that data. The next time a user begins to join a loyalty program, the invention initiates a second loyalty card program application request which is associated with a second loyalty card program. Like the first, the second loyalty card application has data fields, where each data field is either a mandatory data field or an optional data field. Next, the invention automatically populates the data fields associated with the second loyalty card application with data available from the first user input data (where available). Then, for at least each mandatory data field not automatically populated, the user is requested to provide that additional data. Then, the user input data received for the second loyalty card program is stored in the user's account.

Accordingly, those skilled in the art will appreciate that the concept upon which this invention is based may readily be utilized for the design of other devices for carrying out the purposes of this present invention. Therefore, it should also be realized by those skilled in the art that such equivalent constructions do not depart from the spirit and scope of the disclosure as set forth in the appended claims.

### BRIEF DESCRIPTION OF THE DRAWINGS

Various aspects of the invention, as well as an embodiment, are better understood by reference to the following detailed description. To better understand the invention, the detailed description should be read in conjunction with the drawings and tables, in which:

FIG. 1 illustrates an environment in which the invention operates.

FIG. 2 is a flow chart of a process for generating a user rolling profile.

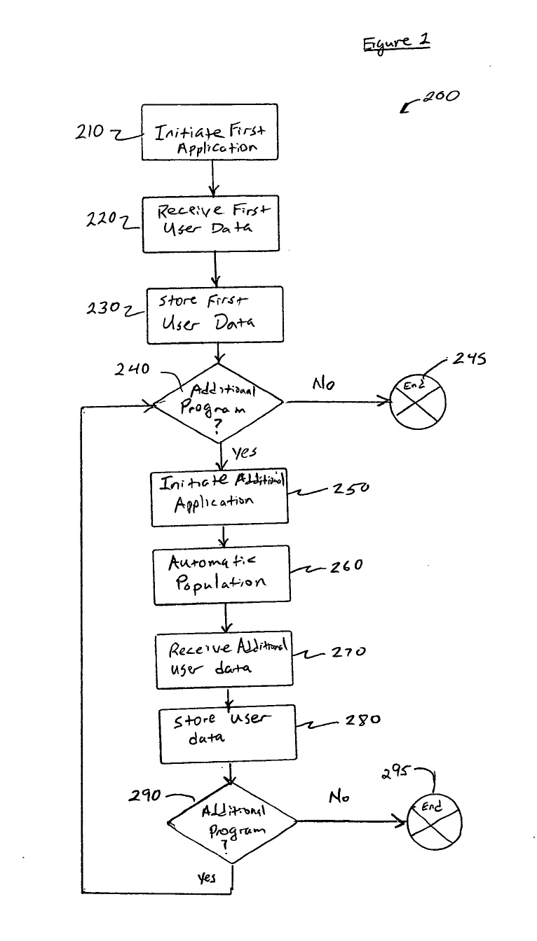

### DETAILED DESCRIPTION OF THE INVENTION

Interpretation Considerations

When reading this section (which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for-functioning-” or “step for-functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium, particularly control and detection/feedback methodologies. Computer-readable mediums include passive data storage, such as a random access memory (RAM) as well as semi-permanent data storage. In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to operate the methods of the invention. It should be noted in the following discussion that acts with like names are performed in like manners, unless otherwise stated. Of course, the foregoing discussions and definitions are provided for clarification purposes and are not limiting. Words and phrases are to be given their ordinary plain meaning unless indicated otherwise.

The numerous innovative teachings of present application are described with particular reference to presently preferred embodiments.

### DESCRIPTION OF THE DRAWINGS

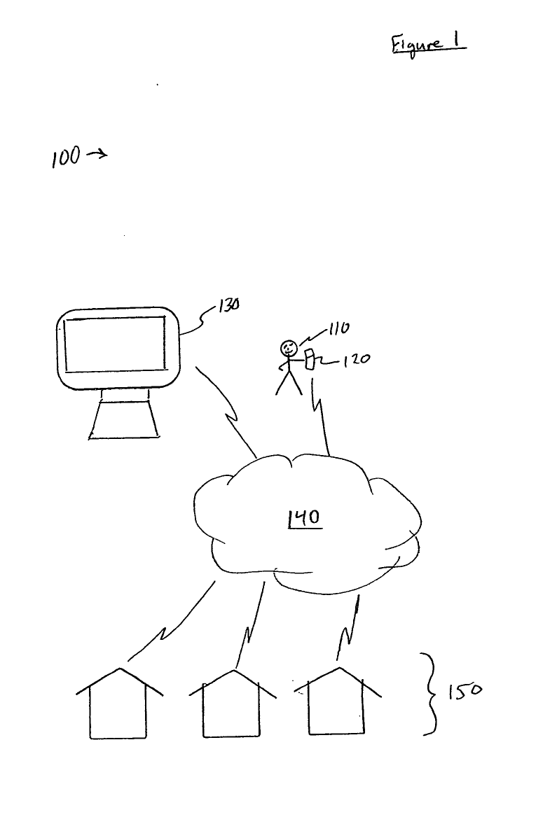

FIG. 1 illustrates a digital loyalty card environment 100. Typically, a user 110 accesses the invention as an app that is downloaded on smart phones having app-compatible operating systems, such as an iPhone® 120 (“the App”). In an alternative embodiment, the invention operates as a standard application which runs on a desktop computers 130 or laptop. The interne 140, when coupled with information gathered by the smart phone 120, makes possible the integration of real-time communication, geo-location, and other user-data such as personal interest either directly entered by the user or surmised by various user behaviors. This data can be brought to bear to enhance experience for the user 110, as well as for driving traffic and revenue to merchants 150.

In one aspect the invention is a method for a processing enrollment into a plurality of loyalty card programs via a mobile device. For purposes of the present discussion, assume that the method is being initiated on behalf of an electronic loyalty card program aggregator functioning in the form of a software application, or “app” (“the App”) preferably on a mobile device.

The method begins in an initiate first application act 210. Here, a user, a third party application or the electronic loyalty card program aggregator itself queries a user for data. When considering the first application act 210, remember that the first loyalty card program application request is associated with a first loyalty card program and a loyalty card enrollee, which in this case is the user. As is understood in the data entry arts, the first loyalty card application has a plurality of data fields. Here, each data field is classified as being either a mandatory data field or an optional data field, meaning that if data is required for a particular data field to complete enrollment in the first loyalty card program, then that data field is said to be mandatory. For example, it is common for the user's name and email are mandatory, but it is not always necessarily so.

Next, in a receive first user data act 220, for at least each mandatory data field, the App receives user input data. A “first set of mandatory data fields data” can be defined as the class of data comprising the data associated with all mandatory data fields associated with the first loyalty card application. Next, in a store first user data act 230, the data associated with the first set of mandatory data fields is stored.

At this time or at a later time, the user may desire to join or may be prompted to join an additional loyalty card program as an additional program query 240. If the user either actively or passively (by, for example, the passage of time or initiation of another app) does not join an additional loyalty card program, then the method ends 245. However, if the user continues to join an additional loyalty card program, the method 200 proceeds to an initiate additional application act 250, in which the additional loyalty card program application request is initiated on the mobile device. Similar to the first application, the second loyalty card application comprises a plurality of data fields where each data field is either a mandatory data field or an optional data field.

Next in an automatic population act 260, the method automatically populates the data fields associated with the second loyalty card application with data available from the first set of mandatory data fields data, where available. Of course, it is conceivable that all the data needed to join the second loyalty card program will be available, however, this is not always the case, particularly when the user has joined one or a just a few loyalty card programs. Accordingly, for at least each mandatory data field not automatically populated, the program must receive additional data, and such data is typically entered by the user in a receive additional user data act 270. At this point, a “second set of mandatory data fields data” is definable as the class comprising all mandatory data fields data associated with the second loyalty card application. Next in a store user data act 280, the data associated with the second set of mandatory data fields is stored.

Once again, the user may join an additional loyalty card program, shown here as a second additional program query 290. If the user either actively or passively does not join an additional loyalty card program, then the method 200 ends 295. However, if the user continues to join an additional loyalty card program, the method 200 returns to the initiate additional application act 250.

The method 200 may be augmented via a variety of functionalities. For example, the act of initiating an application could be generated by a business rules engine. So, each additional loyalty card program could be based on the user's current profile of joined loyalty card programs. Further, the method 200 could initiate an application based on the location of the user at the time the first loyalty card program data is stored, or at the time the user opens (or, “substantiates”) the App. Further, the user could initiate joining a loyalty card program by scanning any one or two-dimensional code, such as QR code, data matrix code, or bar code, for example. Similarly, the method 200 could be initiated by another user of the App “sharing” a loyalty card program offering with the user, which prompts a loyalty card application for the user in the event that the user is not already enrolled in the shared loyalty card program. Alternatively, the user could be prompted to join a plurality of alternative/competing customer loyalty programs based on the user's location. So, for example, restaurants could compete with each other in real time for a specific user by offering enticing customer loyalty deals. Yet another feature could be pushing an electronic coupon to the user as a function of both the first loyalty card program and the second loyalty card program.

Account Creation

Typically, an account for use with the invention is created at the time the user downloads or otherwise gains access to the App. However, there may be a time when a user tries to create an electronic loyalty program card, for example, by scanning a code. In this situation the scanned code triggers the user to first create an account with the App itself prior to enrolling the customer into any loyalty card program. Alternatively, a user may create a passive user account so that loyalty cards may be stored and used electronically without gaining access to the advanced user-features available to users who create an active user account. After downloading the App, a user accesses the most personal benefits of the program by creating a full profile. However, some users will choose to provide only limited information, in which case their participation with loyalty card programs drives their creation of a more-complete user profile, either manually or via a rolling-profile. According, as each loyalty card is added to the App the invention links each and every loyalty card to a single App associated with a user's email address.

Adding and Digitizing Cards

Loyalty cards may be digitized in a number of ways. First, within the App, a user can open the App and select to enter a specific number commonly associated with a reward card. Next, the user will be asked to select the retailer associated with the loyalty card. Second, a user can scan a code, such as a bar code, associated with that reward card, and then follow a similar process of selecting the appropriate retailer. In both of these cases, the App may be able to facilitate retailer selection, based on the code, by reducing the set of all retailers to a much smaller subset of retailers (ie: filtering by barcode type). Once the data is gathered in the App, a virtual barcode is created—a digital image of the barcode—including an image of the bar code and the merchant image associated with that physical loyalty card.

Additionally, a loyalty card program may actually find one of its plastic-carrying loyalty card members via their user profile and invite them to upgrade to an electronic loyalty card program. In the event a loyalty card is not associated with a code, the user will be prompted to enter any information required by the retailer to track and process rewards.

Sharing Loyalty Cards

In one embodiment, in addition to the “sharing” involving friend suggestions previously outlined, benefits are sometimes realizable by sharing a loyalty card. For example, a family may use a single reward card related to a grocer. To share a an account a user accesses the loyalty card in the App, and then enters the email address of the person they wish to share the account with (an account may be shared with more than one person). The other person will receive an email or push notification on their smart phone if they also have the App installed, and all they have to do to tie their accounts together is “accept” the invitation to share the account. If the other person does not have the App installed, they are invited to create an account.

In another embodiment, sharing means one user suggests that another user join a loyalty card program, with each user having their own separate account. For example, a friend who has just had dinner at a new and trendy restaurant may be incentivized to email his friends special offers related to that restaurant's loyalty card program. If the friends also join that restaurant's loyalty card program, then additional rewards may accrue to either or both users.

We claim:

1. A method for a processing enrollment into a plurality of loyalty card programs, the method comprising:
initiating a first loyalty card program application request, the first loyalty card program application request being associated with a first loyalty card program and a loyalty card enrollee;
the first loyalty card application comprising a plurality of data fields, each data field being either a mandatory data field or an optional data field;
for at least each mandatory data field, receiving user input data;
storing the user input data in a user profile;
initiating a second loyalty card program application request, the second loyalty card program application request being associated with a second loyalty card program and the loyalty card enrollee;
the second loyalty card application comprising a plurality of data fields, each data field being either a mandatory data field or an optional data field;
automatically populating the data fields associated with the second loyalty card application with data available from the first user input data, where available;
for at least each mandatory data field not automatically populated, the user provides additional user input data; and
storing the user input data received for the second loyalty card program in the user profile.

2. The method of claim 1, wherein the act of initiating is user-initiated by scanning a code.

3. The method of claim 1, wherein the act of initiating is generated by a business rules engine.

4. The method of claim 3, wherein the second loyalty card program is initiated automatically based on first loyalty card program.

5. The method of claim 1, wherein the second loyalty card program is initiated based on the location of the user at the time the first loyalty card program data is stored.

6. The method of claim 1, wherein the second loyalty card program is initiated based on the location of the user at the time the user substantiates an application that directs the method.

7. The method of claim 1, wherein the first set of mandatory data includes the user's email address.

8. The method of claim 1, further comprising pushing an electronic coupon to the user as a function of both the first loyalty card program and the second loyalty card program.

9. The method of claim 1, further comprising the act of prompting the user to choose from a plurality of loyalty card programs to join based on the user's the geo-location.

10. The method of claim 1, further comprising initiating a third loyalty card program application request, the third loyalty card program application request being associated with a third loyalty card program and the loyalty card enrollee;
the third loyalty card application comprising a plurality of data fields, each data field being either a mandatory data field or an optional data field;
automatically populating the data fields associated with the third loyalty card application with data available from the second set of mandatory data fields data, where available;
for at least each mandatory data field not automatically populated, receiving a user input data; and
storing the user input data in the user profile.

11. The method of claim 1, wherein the application processes through a mobile device.

12. The method of claim 1, wherein the stored user data defines a user profile, and said user profile is associated with an app account.

13. A general computing mobile device that is enhanced with specific functionality through an application which processes information, said processing comprising:
initiating a first loyalty card program application request, the first loyalty card program application request being associated with a first loyalty card program and a loyalty card enrollee;
the first loyalty card application comprising a plurality of data fields, each data field being either a mandatory data field or an optional data field;
for at least each mandatory data field, receiving user input data;
storing the user input data;
initiating a second loyalty card program application request, the second loyalty card program application request being associated with a second loyalty card program and the loyalty card enrollee;
the second loyalty card application comprising a plurality of data fields, each data field being either a mandatory data field or an optional data field;
automatically populating the data fields associated with the second loyalty card application with data available from the first user input data, where available;
for at least each mandatory data field not automatically populated, the user provides additional user input data; and
storing the user input data received for the second loyalty card program in the user profile.

14. The method of claim 13, wherein the act of initiating is user-initiated by scanning a code.

15. The method of claim 13, wherein the act of initiating is generated by a business rules engine.

16. The method of claim 13, wherein the second loyalty card program is initiated automatically based on first loyalty card program.

17. The method of claim 13, wherein the second loyalty card program is initiated based on the location of the user at the time the first loyalty card program data is stored.

18. The method of claim 13, wherein the second loyalty card program is initiated based on the location of the user at the time the user substantiates an application that directs the method.

19. The method of claim 13, further comprising pushing an electronic coupon to the user as a function of both the first loyalty card program and the second loyalty card program.

20. The method of claim 13, further comprising initiating a third loyalty card program application request on the mobile device, the third loyalty card program application request being associated with a third loyalty card program and the loyalty card enrollee;
the third loyalty card application comprising a plurality of data fields, each data field being either a mandatory data field or an optional data field;
automatically populating the data fields associated with the third loyalty card application with data available from the second set of mandatory data fields data, where available;
for at least each mandatory data field not automatically populated, receiving a user input data; and
storing the user input data associated with the third loyalty card program.
